(19) United States
(12) Patent Application Publication
(10) Pub. No.: US 2004/0171427 A1
(43) Pub. Date: Sep. 2, 2004

(54) U-joint face seal

(76) Inventor: John Brian Wagner, Greenfield, IN (US)

Correspondence Address: FREUDENBERG-NOK GENERAL PARTNERSHIP, INTELLECTUAL PROPERTY DEPT., 47690 EAST ANCHOR COURT, PLYMOUTH, MI, 48170-2455, US

(21) Appl. No.: 10/788,097

(22) Filed: Feb. 26, 2004

Related U.S. Application Data
(60) Provisional application No. 60/450,822, filed on Feb. 28, 2003.

(51) Int. Cl. F16D 3/16

(52) U.S. Cl. 464/131

(57) ABSTRACT

A U-joint assembly, including a face seal, is disclosed. The U-joint assembly includes a bearing cup including an outer generally cylindrical surface and an inner generally cylindrical surface, a bearing mounted within the bearing cup against the inner surface, and a shaft having a first cylindrical portion operatively engaging the bearing. The U-joint assembly also includes a face seal including an elastomeric portion, having a generally U-shaped cross section that is adapted to mount over a lip on the bearing cup and including a barb portion adapted to dynamically seal against an outer surface of the bearing cup, and also having a static seal portion adapted to statically seal against the shaft. The assembly also includes a plastic portion connected to the elastomeric portion and adapted to mate with an inner cylindrical surface of the bearing cup such that the barb portion is maintained in sealing contact with the bearing cup.

### BACKGROUND OF INVENTION

This invention relates in general to face seals and more particularly to a face seal used to seal about a shaft.

A face seal is typically employed to seal between a shaft and a bearing cup for a U-joint in a drive line of a vehicle. There are typically four such cups per U-joint assembly, spaced ninety degrees apart, with a first axle having a coupling that holds two of the cups and a second axle having a coupling that holds the other two. The U-joint seals are a dynamic sealing interface in that the shafts rotate relative to their respective cups. The dynamic sealing interface is further complicated by the fact that the seal must allow for any angle difference between shafts or other members connected to the U-joint while still maintaining adequate sealing.

The typical U-joint seal is molded to a steel insert and press fit into the cup, so the seal interface with the cup is a static seal, while the seal interface with the shaft is dynamic. A drawback with such a seal is that, with dynamic sealing on the shaft, contaminants may centrifuge into the cup during axle rotation. This contamination, once inside the cup, will interfere with the internal roller bearings. Moreover, this seal does not generally provide enough support to limit axial movement of the roller bearings. Also, there is the possibility of seal pop-off from the bearing cup due to the seal configuration and the way it is assembled to the other components.

Thus, it is desirable to have a face seal for a U-joint that will better seal out contaminants. It is also desirable to have a face seal for a U-joint that will provide a limit to axial movement of roller bearings in the U-joint, and will provide for better assembly to mating components

### SUMMARY OF INVENTION

In its embodiments, the present invention contemplates a face seal for use with a U-joint in a vehicle drive line, with the U-joint including a shaft and a bearing cup with bearings mounted therein. The face seal includes an elastomeric portion, having a generally U-shaped cross section that is adapted to mount over a lip on the cup and including a barb portion adapted to dynamically seal against an outer surface of the cup, and also having a static seal portion adapted to statically seal against the shaft. The face seal also includes a plastic portion connected to the elastomeric portion and adapted to mate with an inner cylindrical surface of the cup such that the barb is maintained in sealing contact with the cup.

An advantage of an embodiment of the present invention is that contamination is better sealed out of the bearing cup, thus better protecting the bearings.

Another advantage of an embodiment of the present invention is that the seal outside diameter couples to the cup and thus provides for improved rigidity.

A further advantage of an embodiment of the present invention is that the seal supports the roller bearings when pressed against the seal.

An additional advantage of the present invention is that it allows for improved assembly of the components, thus assuring a proper alignment between the seal and the cup and shaft.

### BRIEF DESCRIPTION OF DRAWINGS

FIG. 1 is a schematic, cross sectional view of a face seal mounted on one bearing cup of a U-joint assembly according to the present invention; and

FIG. 2 is a cross sectional view of the face seal, taken from encircled area 2 in FIG. 1, prior to assembly to the cup and shaft.

### DETAILED DESCRIPTION OF THE PREFERRED EMBODIMENTS

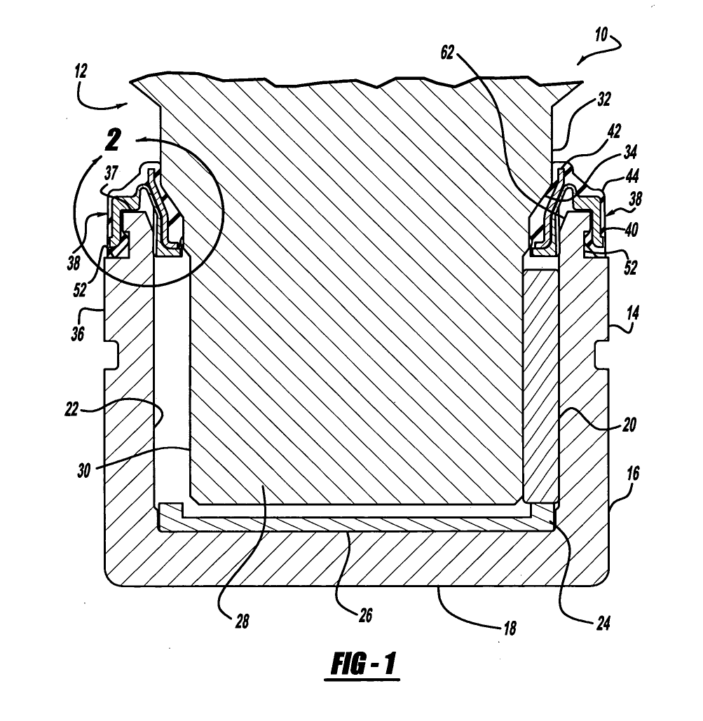

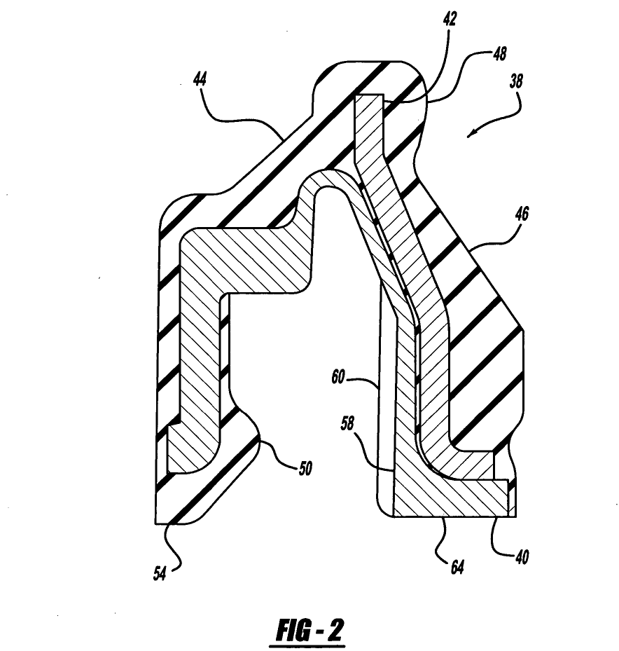

FIGS. 1 and 2 illustrate a first portion 12 of a U-joint 10 that may be employed, for example, in a drive line of a vehicle. The U-joint 10 may include four identical portions 12, spaced at generally ninety degrees, as is conventional in the art. The first U-joint portion 12 includes a bearing cup 14, having a generally cylindrical wall 16 integral with a circular end 18, with the bearing cup 14 being preferably made of steel or other suitable metallic materials, although various synthetic materials might be used in appropriate applications. A set of roller bearings 20 (only one of which is shown in FIG. 1, for clarity) mount adjacent an inner cylindrical surface 22 of the cup 14, and their travel is axially limited on their first ends 24 by a wafer 26. The wafer 26 is preferably nylon, although other suitable materials, such as other plastics or synthetics, may also be employed.

A shaft 28 has a cylindrical end portion 30 that fits radially inward of and is in rotational contact with the roller bearings 20. The shaft 28 also includes a second cylindrical portion 32 that is radially larger than the end portion 30. A conical step portion 34 tapers radially outwardly as it extends from the cylindrical end portion 30 to the second cylindrical portion 32.

A face seal 38 mounts between the shaft 28 and bearing cup 14. The face seal 38 includes a plastic portion 40 (preferably nylon, although other suitable plastics or synthetics may also be used) and a preferably metal insert 42 (preferably steel, although various suitable plastics can also be used) that are preferably molded to an elastomeric (preferably rubber, for example) portion 44. The face seal 38 is generally U-shaped, so it is in contact with the inner cylindrical surface 22 and an outer cylindrical surface 36 adjacent a circular lip 37 of the cup 14.

The elastomeric portion 44 includes an abutment surface 46, which is shaped to abut the conical step portion 34 of the shaft 28. It also includes a seal portion 48, which has a diameter that is preferably smaller than the diameter of the second cylindrical portion 32 in order to create an interference sealing fit with the shaft 28. The surface of the seal portion 48 may take the shape of a sealing bead, if so desired, in order to create a seal “line” or “band” area about the circumference of the shaft 28 with a predetermined sealing force. This seal portion 48 forms a static seal with the shaft in order to prevent contaminants from migrating along the shaft into the bearing cup 14, thus protecting the roller bearings 20.

The elastomeric portion 44 also includes a barb 50, which is received within and seals against a cylindrical channel 52 formed in the wall 16 of the cup 14, and a sealing extension 54, which also seals against the channel 52. Since the face seal 38 is essentially rotationally fixed relative to the shaft 28, the barb 50 and the sealing extension 54 will rotate relative to the cup 14, thus providing a dynamic seal. This dynamic seal will prevent contaminants from migrating over the lip 37 and into the cup 14 during vehicle operation. Also, since the barb 50 is retained within the channel 52, it will help retain the seal 38 on the bearing cup 14, reducing the chances that the seal 38 will pull off of the cup 14. One will also note that the elastomeric portion 44, due to the shape of the seal and due to the fact that it is preferably molded over the preferably metal insert 42 and the nylon portion 40, is the only portion of the seal 38 that is exposed to external elements and contaminants. Thus, choosing the correct corrosion resistant elastomeric material for the elastomeric portion 44 will protect the other two portions from corrosion or other damage that may be caused by exposure to harsh elements.

The preferably nylon portion 40 includes a generally cylindrical portion 58 that has optional ribs 60 extending radially outward therefrom. The ribs 60 are in surface contact with the inner cylindrical surface 22 of the cup 14. The gap between the barb 50 and ribs 60 is smaller than the thickness of the cup 14 at that location in order to create an interference fit. This interference fit creates the sealing force tending to hold the barb 50 against the channel 52, thus providing an interference fit at least during assembly, if needed. It should be noted, however, that the ribs 60 can be eliminated if found not to be needed for assembly purposes. Although the ribs 60 are frequently not necessary (i.e. the cylindrical portion 58 can be placed partially directly in surface contact, or at least closely adjacent, with the cup), but they reduce the force needed during assembly of the seal 38 to the cup 14 and reduce the amount of friction generated by the seal 38 rotating relative to the cup 14—since the amount of nylon in surface contact with the cup 14 is substantially reduced—while maintaining the rigidity of the seal.

The plastic portion 40 is preferably nylon because this material provides for a relatively low coefficient of friction when sliding relative to the cup. Thus, a minimum amount of overall friction between the seal 38 and the cup 14 is assured so that the seal 38 rotates relative to the cup 14 and not the shaft 28. Also, preferably, the inner cylindrical surface 22 includes a tapered portion 62 adjacent the lip 37 in order to ease assembly of the face seal 38 to the bearing cup 14.

The plastic portion 40 also preferably includes an abutment leg 64 against which the roller bearings 20 will press, if the bearings 20 begin to migrate axially in an outward direction relative to the cup 14. Any axial force exerted by the bearings 20 against the leg 64 will transfer through the seal and be counteracted by the abutment surface 46 pressing against the conical portion 34 of the shaft 28. This configuration, then, will help prevent the bearings 20 from pushing the face seal 38 out of the cup 14. Again, the plastic portion 40 is preferably nylon in order to reduce friction between the seal 38 and any bearings 20 that migrate into contact with the seal.

The metal insert 42 in the face seal 38 is optional but may preferred in some applications because it provides two functions. First, it provides stiffness for transferring the axial load received by the leg 64 to the abutment surface 46. Second, it can provide rigidity to the seal 38 to assure that the proper sealing load is maintained by the barb 50 against the channel 52 in the cup 14, although its main purpose, when used, is to resist creep of the synthetic or elastomeric components, as well as thermal stability. This overall seal configuration, then, will provide for the amount of flexibility needed to assemble the seal 38 to the cup 14 and to allow for any relative angle difference between caused by relative orientation between the drive shaft (not shown) and other components of the U-joint (when it occurs), while still maintaining the rigidity (with or without the metal insert 42) needed to provided adequate sealing forces for the dynamic seal and prevent the bearings 20 from pushing the seal 38 out of the cup 14.

While certain embodiments of the present invention have been described in detail, those familiar with the art to which this invention relates will recognize various alternative designs and embodiments for practicing the invention as defined by the following claims.

What is claimed is:

1. A face seal for use with a U-joint, with the U-joint including a shaft and a bearing cup with bearings mounted therein, the face seal comprising:
an elastomeric portion, having a generally U-shaped cross section that is adapted to mount over a lip on the bearing cup and including a barb portion adapted to dynamically seal against an outer surface of the bearing cup, and also having a static seal portion adapted to statically seal against the shaft; and
a plastic portion connected to the elastomeric portion and adapted to mate with an inner cylindrical surface of the bearing cup such that the barb portion is maintained in sealing contact with the bearing cup.

2. The face seal of claim 1 further including a stiffening insert connected to the elastomeric portion and extending adjacent the plastic portion.

3. The face seal of claim 2 wherein the stiffening insert is made of metal.

4. The face seal of claim 1 wherein the elastomeric portion is made of rubber.

5. The face seal of claim 1 wherein the plastic portion is formed of nylon.

6. The face seal of claim 1 wherein the elastomeric portion includes an abutment portion that is adapted to abut a conical portion of the shaft.

7. The face seal of claim 1 wherein the plastic portion includes an abutment leg adapted to abut against and limit axial movement of the bearings.

8. The face seal of claim 1 wherein the barb portion is adapted to mount within a channel of the bearing cup.

9. A U-joint assembly comprising:
a bearing cup including an outer generally cylindrical surface and an inner generally cylindrical surface;
a bearing mounted within the bearing cup against the inner surface;
a shaft having a first cylindrical portion operatively engaging the bearing; and
a face seal including an elastomeric portion, having a generally U-shaped cross section that is adapted to mount over a lip on the bearing cup and including a barb portion adapted to dynamically seal against an outer surface of the bearing cup, and also having a static seal portion adapted to statically seal against the shaft; and a plastic portion connected to the elastomeric portion and adapted to mate with an inner cylindrical surface of the bearing cup such that the barb portion is maintained in sealing contact with the bearing cup.

10. The U-joint assembly of claim 9 further including a stiffening insert connected to the elastomeric portion and extending adjacent the plastic portion.

11. The U-joint of claim 9 wherein the shaft includes a conical portion adjacent the first cylindrical portion and tapering radially outward, and the elastomeric portion includes an abutment portion that abuts the conical portion.

12. The U-joint of claim 9 wherein the plastic portion includes an abutment leg adapted to abut against and limit axial movement of the bearings.

13. The U-joint of claim 9 wherein the bearing cup includes a channel about the outer cylindrical surface and the barb portion is adapted to mount within the channel to thereby retain and dynamically seal to the bearing cup.

14. The U-joint of claim 9 wherein the plastic portion includes a plurality of ribs in surface contact with the inner cylindrical surface of the bearing cup.
